(19) United States
(12) Patent Application Publication
(10) Pub. No.: US 2016/0373155 A1
(43) Pub. Date: Dec. 22, 2016

(54) REMOVABLY ATTACHABLE MOBILE DEVICE CASE AND ACCESSORIES

(71) Applicant: olloclip, LLC, Huntington Beach, CA (US)

(72) Inventors: Patrick D. O'Neill, Huntington Beach, CA (US); Chong Pak, Lakewood, CA (US); Jason Patrick, Long Beach, CA (US); Daniel Arato, Los Angeles, CA (US); Joshua Cantor, Huntington Beach, CA (US); Ryan Nguyen, Fountain Valley, CA (US); Robert O'Neill, Huntington Beach, CA (US)

(21) Appl. No.: 15/188,764

(22) Filed: Jun. 21, 2016

Related U.S. Application Data
(60) Provisional application No. 62/183,120, filed on Jun. 22, 2015.
(60) Provisional application No. 62/183,660, filed on Jun. 23, 2015.

(51) Int. Cl. H04B 1/3888; A45C 11/00

(52) U.S. Cl. CPC H04B 1/3888; A45C 11/00; A45C 2011/002; A45C 2011/003

(57) ABSTRACT

Removably-attachable cases for mobile electronic devices are provided. A removably-attachable case may include an attachment region to which accessories can be attached for use with the mobile electronic device onto which the case has been installed. The accessories may include illumination components (e.g., flashes for flash photography), recording components (e.g., microphones), support components (e.g., tripods, handles), other accessories, accessory mounting components, some combination thereof, etc. A removably attachable case may also or alternatively include an access region configured to provide access to a component of a mobile electronic device onto which the case is removably attached.

### CROSS-REFERENCE TO RELATED APPLICATIONS

This application claims the benefit of U.S. Provisional Patent Application No. 62/183,120, filed on Jun. 22, 2015 and entitled “REMOVABLY ATTACHABLE MOBILE DEVICE CASE AND ACCESSORIES,” and U.S. Provisional Patent Application No. 62/183,660, filed on Jun. 23, 2015 and entitled “REMOVABLY ATTACHABLE MOBILE DEVICE CASE AND ACCESSORIES,” the entire contents of both of which are hereby incorporated by reference herein and made part of this specification for all that they disclose.

### BACKGROUND

Field of the Inventions

The inventions relate generally to accessories for mobile electronic devices (e.g., mobile telephones, mobile texting devices, electronic pad devices, laptop computers, desktop computers, gaming devices, and/or devices capable of linking electronically to another device or to a network such as the Internet, etc.), and specifically to cases and removable functional components for mobile electronic devices.

Description of the Related Art

In recent years, many advances in computer networking and processing technology have made it possible for mobile electronic devices to include cameras that permit users to capture images. In many cases, these images can be stored, processed, and transmitted. However, there are many design constraints on onboard cameras in mobile electronic devices that can limit the weight, size, expense, shape, adjustability, and overall quality of the lensing systems of such cameras. Consequently, many cameras in mobile electronic devices do not provide a wide variety of photographic features desired by users.

The deficiencies of onboard camera lenses can be addressed by modular or detachable lensing systems. Such lensing systems may be mounted or attached to mobile electronic devices such that one or more auxiliary lenses are positioned substantially over the onboard camera lenses of the mobile electronic devices. The auxiliary lenses can enhance or alter the light that may be captured by the onboard cameras to generate an image.

Other accessories may be used with mobile electronic devices, such as protective cases. Protective cases are generally intended to provide protection for the mobile electronic devices onto which they are installed, and to inhibit wear and/or damage to the mobile electronic devices. Conventionally, protective cases cover the exterior of the mobile electronic device, or some portion thereof, to cushion impacts, protect against scratches, and the like.

### BRIEF DESCRIPTION OF THE DRAWINGS

Certain embodiments of the inventions will now be discussed in detail with reference to the following figures. These figures are provided for illustrative purposes only, and the inventions are not limited to the subject matter illustrated in the figures.

FIG. 1 illustrates an example of a case for a mobile electronic device.

FIGS. 2A and 2B illustrate an example of a mobile electronic device and a case for the mobile electronic device.

FIG. 3 illustrates example accessories attached to the case and mobile device of FIGS. 2A and 2B.

FIG. 4 illustrates additional example accessories attached to the case and mobile device of FIGS. 2A and 2B.

FIGS. 5A, 5B, 5C, 5D, 5E, and 5F illustrate example accessories being attached to and used with the case of FIG. 1.

FIG. 6 illustrates an example of a case installed on a mobile electronic device.

FIG. 7 illustrates a cross section of the case along the A-A line of FIG. 6.

FIGS. 8A and 8B illustrate views of an example case accessory with a cold shoe.

FIGS. 9A and 9B illustrate views of an example case accessory with a threaded mount.

FIGS. 10A and 10B illustrate views of another example case accessory with a threaded mount.

FIGS. 11A, 11B, and 11C illustrate views of an example case accessory with a handle.

### DETAILED DESCRIPTION OF ILLUSTRATIVE EMBODIMENTS

The following detailed description is now directed to certain specific illustrative embodiments of the disclosure. In this description, reference is made to the drawings wherein like parts are designated with like numerals throughout the description and the drawings. The inventions are not limited to the examples expressly illustrated in the drawings or described in this specification. As used herein, a mobile device refers to a device that can be readily and conveniently carried by a user from one place to another; a mobile electronic device is a mobile device that comprises one or more electronic capabilities; a mobile electronic communication device is a mobile electronic device that comprises one or more communication features that permit the device to communicate with one or more other devices.

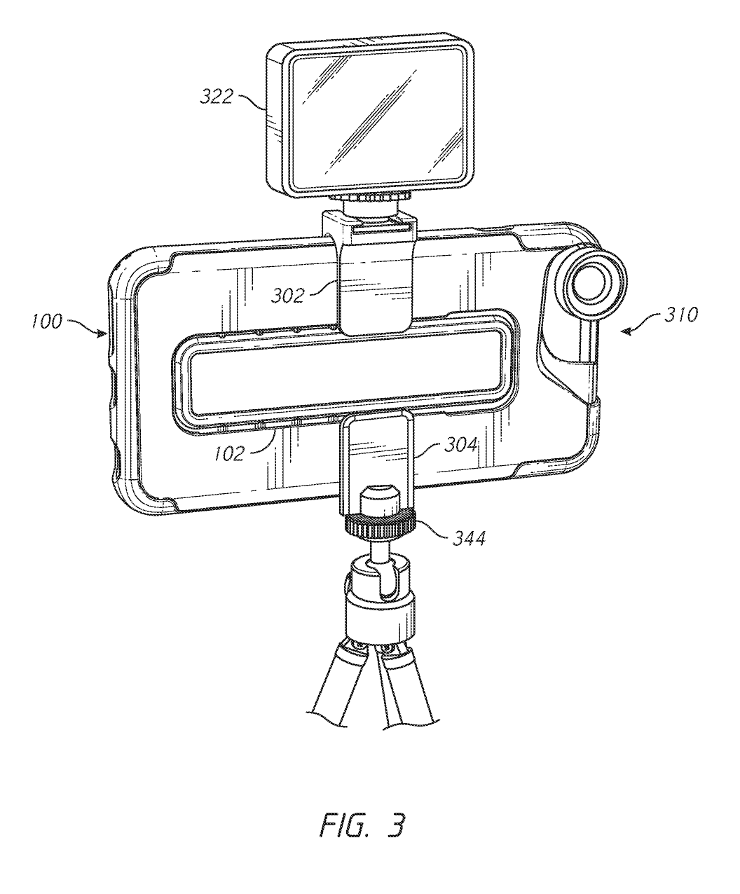

Any feature, structure, step, material, or component that is illustrated and/or described in any embodiment in this specification can be used separately from the embodiment in which it is disclosed and/or illustrated, either individually, or in combination with another embodiment described and/or illustrated in this specification, or in combination with an embodiment that is not described and/or illustrated in this specification. For example, without limitation, any embodiment in this specification can include multiple accessories attached or attachable to a single case, as illustrated in FIGS. 3, 4, and 5, even if not illustrated or described. As another example, any embodiment in this specification can be configured to be attached to, and detached from, a case for a mobile electronic device by a user without requiring tools or separate mounting components (e.g., screws). No feature, structure, step, material, or component disclosed and/or illustrated in this specification is essential or indispensable.

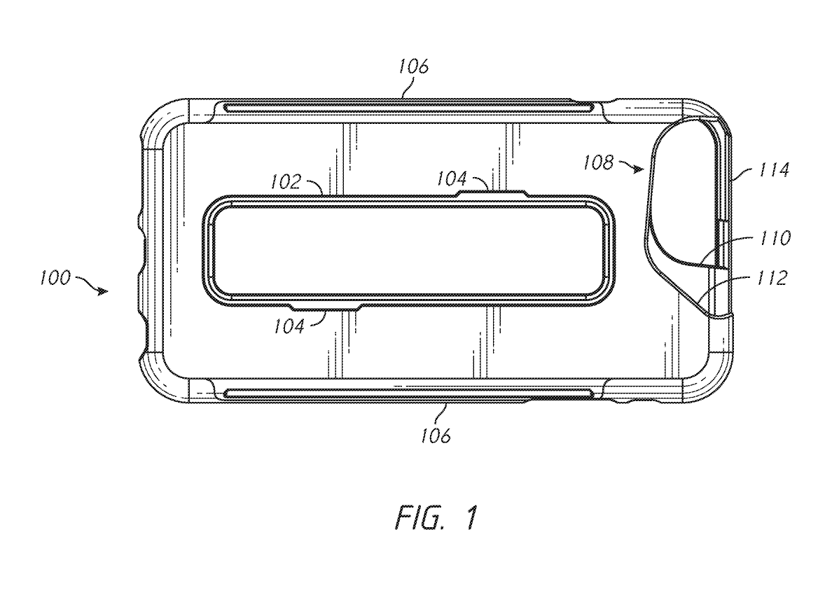

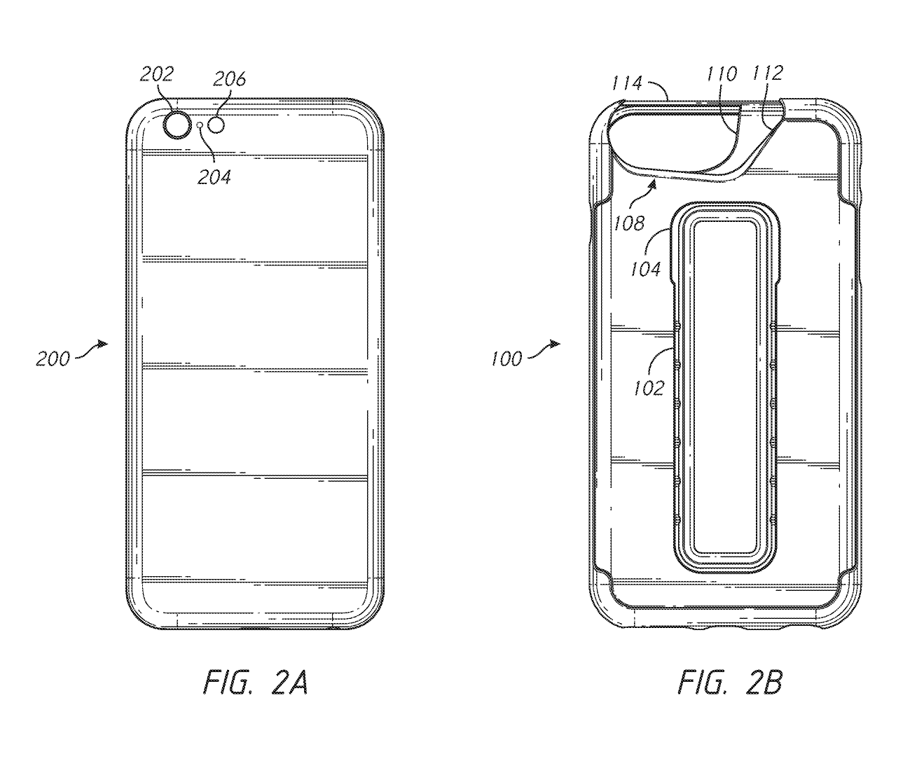

Referring to FIGS. 1-7, examples of removably attachable cases 100 for mobile electronic devices 200 are illustrated. A user may removably attach or otherwise install a case 100 on a mobile electronic device 200 without using additional fasteners or tools. For example, the case 100 may be “snapped” and/or slid onto the outer housing of a mobile electronic device 200, and/or the case 100 (or portions thereof) may be flexible and resilient to allow the case 100 (or portions thereof) to be expanded or otherwise deformed for gripping onto and/or attachment to the outer housing of the mobile electronic device 200.

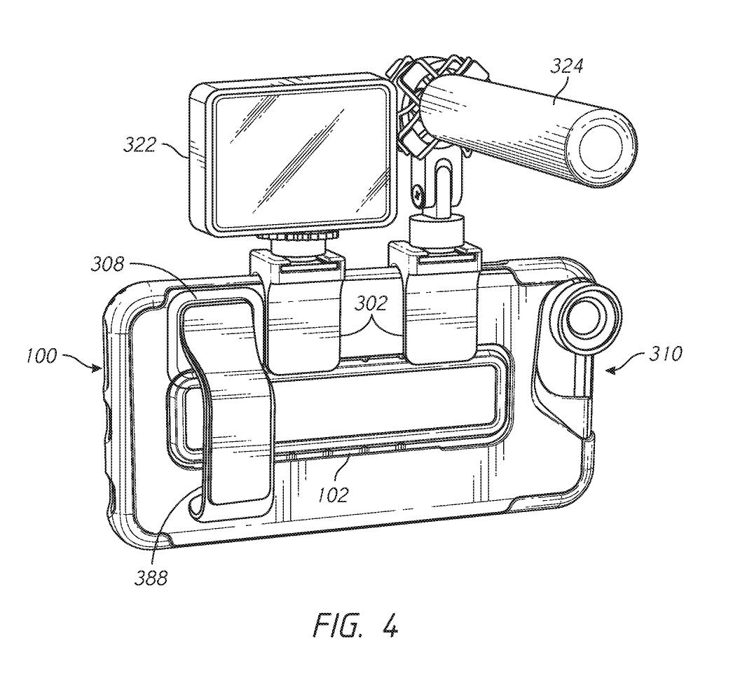

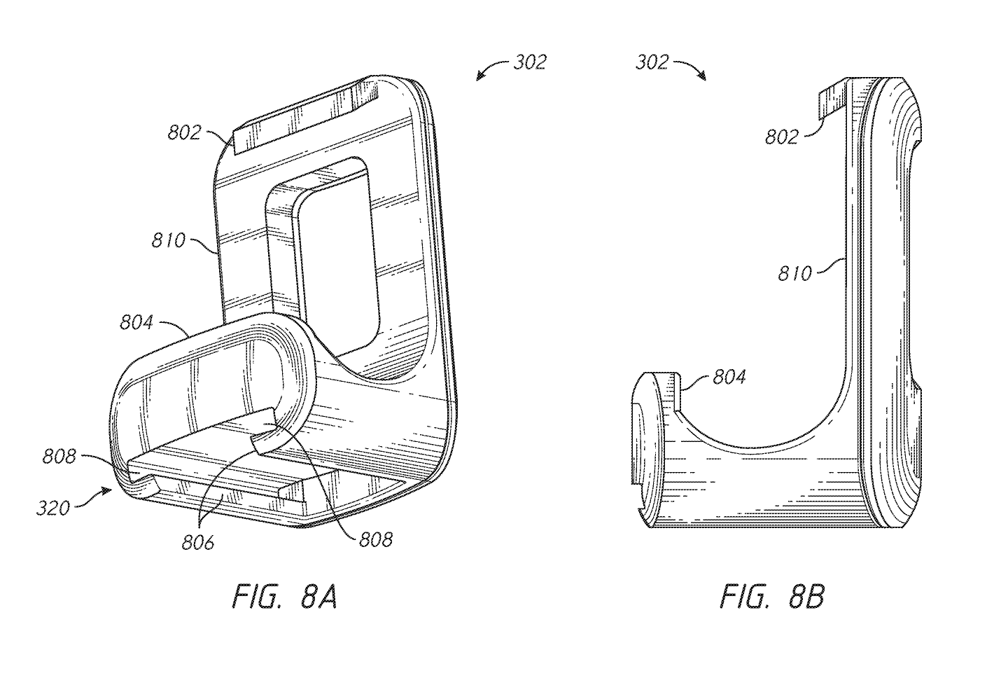

In some embodiments, as shown, a case 100 may include an attachment region 102 to which accessories can be attached for use with the mobile electronic device 200 onto which the case 100 has been installed. The accessories may include illumination components (e.g., flashes for flash photography), recording components (e.g., microphones), support components (e.g., tripods, handles), other accessories, accessory mounting components, some combination thereof, etc. For example, as shown in FIGS. 3 and 4, an accessory mounting component 302 that has a mounting portion, such as a cold shoe or a hot shoe, may be attached to the case 100 as described in greater detail below. A cold shoe can comprise a mounting component that does not provide electrical communication on, within, and/or through the mounting component; and a hot shoe can comprise a mounting component that does provide electrical communication on, within, and/or through the mounting component. For convenience, in some embodiments, this specification refers separately to “cold shoe” and “hot shoe” mounting components, but any reference anywhere in this specification to a cold shoe mounting component can applied to or used with a hot shoe mounting component, and any reference anywhere in this specification to a hot shoe mounting component can be applied to or used with a cold shoe mounting component. The accessory mounting component 302 may facilitate attachment of a flash 322, microphone 324, etc. Some accessory mounting components 304 may have a different mounting portion, such as a threaded mounting portion. The accessory mounting component 304 shown with a threaded mounting portion may be attached to the case 100 to facilitate use of a tripod 344 or some other support structure with the mobile device 200. Another example accessory that may be attached to the case 100 is a gripping or holding component, such as a handle 388. The handle 388 can be used to allow users a more comfortable and/or secure grip on the mobile device 200 during use, such as when taking photographs. Users may attach the handle 388 to the case 100 via an accessory mounting component 308 integrated with the handle 388 or configured for attachment of the handle 388. Although portions of this disclosure focus, for convenience and simplicity, on accessory mounting components 302 with cold shoe mounts, it will be understood that any other accessory mounting component or accessory may be used in a similar manner with any of the embodiments and examples described herein. Additional examples of accessory mounting components and accessories are described in greater detail below with respect to FIGS. 8-11.

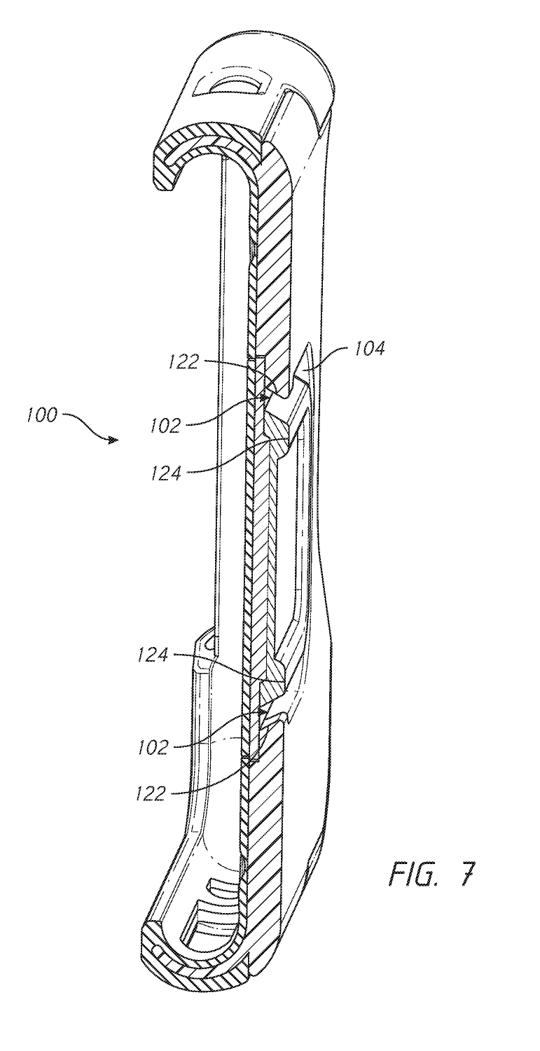

In some embodiments, the attachment region 102 of the case 100 may be or include a portion that is recessed into or below an outer surface of the case 100 (where the outer surface is the surface that faces outward from case 100 and is generally parallel with an inner surface of the case 100 that contacts a mobile device 200). For example, the attachment region 102 may be a channel or groove in the outer surface of the case 100. In other embodiments, the attachment region 102 may be or include a portion, such as a rail or a tab, that is protruding or proud of an outer surface of the case 100. The attachment region 102 (whether a channel, groove, rail, tab, or some other structure) may be sized, shaped, or otherwise configured to secure accessories or accessory mounting components 302 to the case 100. The attachment region 102 may include an opening 104 into which a portion of an accessory mounting component 302 may be inserted, such as a portion having a shape at least partially complementary to the shape of the channel or groove of the attachment region 102. For example, if the attachment region 102 is or includes a channel configured to retain an accessory mounting component 302, the opening 104 may be or include an enlargement to the channel in order to facilitate insertion and/or removal of an accessory mounting component 302 into/out of the channel. An example of an attachment region 102 configured as a channel is described in greater detail below with respect to FIG. 7.

The attachment region 102 may be located on the case 100 such that it is adjacent to a rear face of a mobile device 200 when the case 100 is installed on the mobile device 200. For example, the mobile device 200 may have a substantially planar front face that includes a screen and/or other user-facing components. The mobile device 200 may also include a substantially planar rear face that is substantially parallel to the front face. The case 100 may be attached to the mobile device 200 such that it covers all or a substantial portion of the rear face without covering a substantial portion of the front face. The attachment region 102 may be positioned on the portion of the case 100 that covers the rear face of the mobile device 200.

As shown in FIGS. 1-6, the attachment region 102 may be substantially rectangular in shape. The perimeter of such a substantially rectangular attachment region 102 may be defined by a channel that facilitates attachment of accessories, as described above and in greater detail below. In some embodiments, the perimeter of the attachment region 102 may be a different shape, such as a square, parallelogram, trapezoid, triangle, circle, oval, etc. In some embodiments, an attachment region may be a single substantially straight or curvilinear channel, or it may include multiple (e.g., two or more) separate substantially parallel or non-parallel channels, etc.

In some embodiments the case 100 may include a mobile device component access portion 108. The component access portion 108 can include an opening to allow direct access to components of the mobile device 200 to which the case 100 is attached, such as an onboard camera lens 202, microphone 204, flash component 206, and/or other input/output components. The case 100 may include a support member 114 that partially surrounds or defines the component access portion 108, provides rigidity and stability to the case 100, and/or protects an edge of the mobile device 200.

The opening of the component access portion 108 can expose one or more portions of the mobile device 200 surrounding the onboard camera lens 202 and/or other components. For example, in addition to providing access to the onboard camera lens 202 and reducing or eliminating undesired obstruction of the camera 202 during use, the component access portion 108 can permit attachment of one or more auxiliary components onto the mobile device 200 while the case 100 is installed on the mobile device 200. As shown in FIGS. 3 and 4, the component access portion 108 may facilitate attachment of an auxiliary optical component 310 to the case 100 and/or mobile device 200 such that the auxiliary optical component 310 can be used with, e.g., the onboard camera 202 of the mobile device 200 onto which the case 100 is installed. Illustratively, the optical component access portion 108 may be sized and/or shaped to facilitate attachment of an auxiliary lens device, such as the “4-in-1 Lens” product designed by olloclip, LLC in Huntington Beach, Calif. Various examples of auxiliary optical components that may be used with the case 100 are shown and described in U.S. patent application Ser. No. 14/743,593, filed on Jun. 18, 2015 and entitled “AUXILIARY OPTICAL COMPONENTS FOR MOBILE DEVICES,” the entire contents of which are incorporated by reference herein.

The auxiliary optical component 310 may be sized and/or shaped such that it can receive the support member 114 and still be properly installed onto the mobile device 200 and aligned with the onboard camera lens 202 and/or other components of the mobile device 200. A user may therefore attach and use an auxiliary optical component 310 in the same or substantially the same way as when using the auxiliary optical component 310 with the mobile device 200 without a case 100. The case 100 may also have one or more guides or other structures to aid in alignment of an auxiliary optical component 310. For example, as shown, the component access portion 108 may have edges 110 and/or 112. When an auxiliary optical component 310 is attached to mobile device 200, one or more of the edges 110, 112 of the component access portion 108 can guide the auxiliary optical component 310 onto the mobile device 200 in a desired orientation and/or alignment with respect to a component of the mobile device 200 such as the onboard camera lens 202. The component access portion 108 may have two edges 110 and 112 that correspond to two different interior and/or exterior surfaces of an auxiliary optical component 310, or to two different positions in which the auxiliary optical component 310 can be mounted on the mobile device 200. In some embodiments, the component access portion 108 may have two or more edges which correspond to two or more different auxiliary optical components 310.

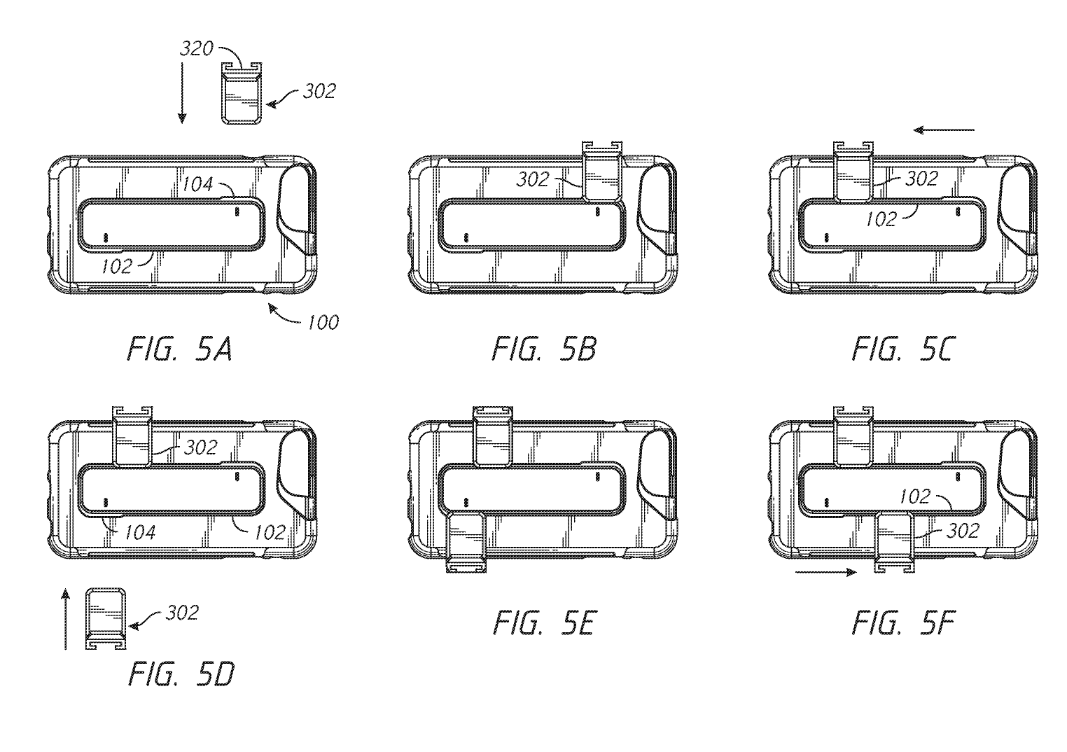

As shown in FIGS. 5A-5F, an accessory mounting component 302 with a cold shoe 320 may be attached to the case 100 via the opening 104 of the attachment region 102. The cold shoe 320 of the accessory mounting component 302 can facilitate use, with the mobile device 200, of a variety of components configured for use with a cold shoe 320 (e.g., an auxiliary flash or microphone component, as shown in FIGS. 3-4). A user can advance the accessory mounting component 302 toward the opening 104 of the attachment region 102 as shown in FIG. 5A. A securement member (e.g., hook, arm, tab, or other protrusion) of the accessory mounting component 302 can be inserted into the opening 104. A second securement member (e.g., a hook or arm) of the accessory mounting component 302 can be placed on or over an edge of the case 100 that is spaced away from, and is substantially parallel to, at least a portion of the attachment region 102. The user can then move the accessory mounting component 302 away from the opening 104, as shown FIGS. 5B and 5C. For example, the user can push or slide the accessory mounting component 302 along the channel of the attachment region 102 such that the securement member is retained within the channel of the attachment region 102 and the accessory mounting component 302 is fastened to the case 100. An example of the structure of the channel of the attachment region 102 is shown in FIG. 7 and described in greater detail below, and examples of securement members are shown in FIGS. 8-11 and described in greater detail below.

In some embodiments, multiple (e.g., two or more) accessory mounting components 302 can be attached to the case, as shown in FIGS. 5D-5F. For example, after attaching the first accessory mounting component 302 as described above, the user may advance a second accessory mounting component 302 toward a second opening 104 of the attachment region 102, as shown in FIG. 5D. The user may then insert a securement member of the second accessory mounting component 302 into the second opening 104, and move the accessory mounting component 302 away from the second opening 104 to secure the second accessory mounting component 302 to the case 100, as shown in FIGS. 5E and 5F.

The case 100 may include a second attachment region 106, such as a second channel or groove into which a portion of an accessory mounting structure 302 may be inserted. As shown in FIG. 1, the second attachment region 106 may be located on an outer edge of the case 100, and may be spaced away from the attachment region 102 and substantially parallel to at least a portion of the attachment region 102. The second attachment region 106 can provide a second point of attachment (along with the attachment region 102) for a single accessory mounting component 302 such that the accessory mounting component 302 is secured to the case 100 at two points. In some embodiments, the second attachment region 106 can provide an alternative to the attachment region 102. In some embodiments, there may be three, four, or more separate attachment regions, any one or more which may be used independently or in combination with any one or more of the others to secure accessories, accessory mounting component 302, and the like.

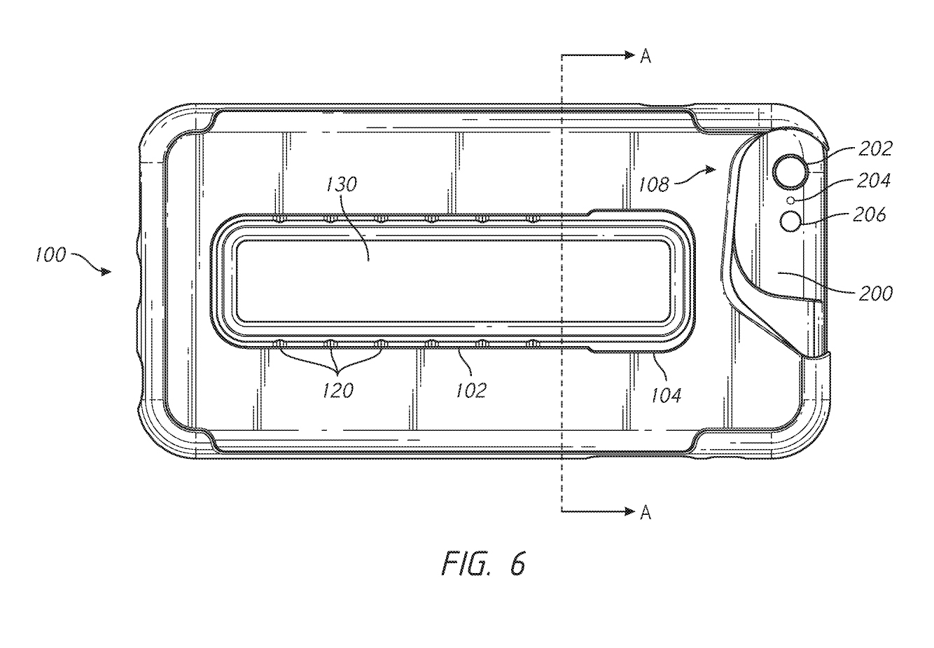

FIG. 6 shows another example of an attachment region 102 with an opening 104. As shown, the opening 104 extends around two corners of the substantially rectangular attachment region. In some embodiments, the opening may extend around only one corner of the attachment region. In some embodiments, a case 100 may include an accessory region 130 that is removable and replaceable. The accessory region 130 may be removed from the case 100 and replaced with other components, such as an auxiliary battery, handle, illumination element (flash component for flash photography), support component (e.g., tripod), or the like. As shown, the accessory region 130 may comprise a region partially or completely surrounded by the attachment region 102 (e.g., the accessory region may be a removable/replaceable “island”). In some embodiments, the accessory region 130 may be a region that is not completely or even partially surrounded by, or is otherwise separate from, the attachment region 102. In some embodiments, the accessory region 130 may be attached to the case 100 via a removable attachment, such as a snap fit, friction fit, or interference fit, through an interior face of the case 100 such that it is visible from outside of the case 100 when the case 100 is installed on a mobile device 200. For example, the case 100 may be removed from the mobile device 200, and the accessory region 130 may be attached/removed/replaced prior to re-attachment of the case 100 to the mobile device 200. A handle component may be inserted in place of the accessory region 130. The handle may include a hinge or folding element such that the handle may be pivoted or folded into or against the case 100 when not in use, and then unfolded or pivoted away from the case to be used. In some embodiments, a flash component may be inserted in place of the accessory region 130. The flash component may include an illumination element and integrated battery to power the illumination element, or the flash component may be powered by the mobile device 200 via a wired connection. The flash component may be wirelessly controlled by the mobile device 200, or the flash component may communicate with the mobile device 200 via a wired connection. In some embodiments, a support component such as a monopod or tripod may be inserted in place of the accessory region 130. The support component may include a hinge or folding element such that the support component may be pivoted or folded into or against the case 100 when not in use, and then unfolded or pivoted away from the case 100 to be used. In some embodiments, the accessory region 130 may be replaced by another accessory region 130 that has a different color, texture, or design, or that covers the channel of the attachment region 102 to provide a substantially flat, uninterrupted surface for the case 100.

In some embodiments, the attachment region 102 may include one or more alignment structures 120, as also shown in FIG. 6. For example, the attachment region 102 may be a channel, and an alignment structure 120 such as a tab or detent may be located within the channel. The alignment structure 120 can provide a positive stop for accessory mounting components 302, providing a user with predefined locations at which accessory mounting components 302 can be positioned. A securement member of an accessory mounting component 302 may abut or otherwise contact an alignment structure 120, and the alignment structure may inhibit further movement of the securement member along the channel until a threshold amount of force is applied. Thus, the accessory mounting component 302 can be maintained in a particular location and secured from accidental movement.

FIG. 7 shows a cross section of a case 100 along the A-A line of the case 100 illustrated in FIG. 6. As seen in FIG. 7, the channel of the attachment region 102 may be defined by at least two sidewalls 122, 124. A first sidewall 122 may be angled or sloped toward the second sidewall 124, such that an upper edge of the first sidewall 122 is approximately centered above the channel width-wise (e.g., about midway between the base of the first sidewall 122 and the base of the second sidewall 124, which define the lower portion of the channel). In this orientation, the upper edge of the first sidewall 122 may form a lip. A hook, arm, or other securement member of an accessory mounting component 302 can use the lip to secure the accessory mounting component 302 to the case 100 (e.g., the securement member can “hook” onto the lip of the first sidewall 122). The second sidewall 124 may be angled or sloped away from the first sidewall 122 such that the second sidewall 124 is substantially parallel to the first sidewall 122. The second sidewall 124 may be oriented in this way to allow easier movement of a securement member along the channel and along the lip formed by the angled first sidewall 122. In some embodiments, the channel is not formed by two substantially parallel angled sidewalls 122, 124. Rather, the channel may be a “T-track” channel in which the base or interior or lower portion of the channel is larger than an outer or upper or exterior portion of the channel, and the channel appears to have roughly the shape of the letter “T” when viewed in cross-section. Any other channel configuration may be used.

FIG. 8 shows an example of an accessory mounting component 302 with a cold shoe 320. The accessory mounting component 302 can have a securement member 802 that is sized and/or shaped to be complementary to the attachment region 102 of the case 100. For example, the securement member 802 may be a tab, arm, or hook that is configured to be inserted into the channel of the attachment region 102 shown in FIG. 7, between the first and second sidewalls 122, 124. The securement member 802 may have two substantially parallel outer walls that are angled or sloped with respect to a surface 810 from which the securement member 802 protrudes. When the accessory mounting component 302 is attached to the case 100 via the attachment region 102, the securement member 802 may be inserted into the opening 104 of the attachment region 102. The surface 810 may be placed against the outer surface of the case 100, adjacent to the attachment region 102. The accessory mounting component 302 may then be moved along the channel of the attachment region 102 to a desired position on the case 100, as shown in FIG. 5. The securement member 802 may be retained within the channel while the surface 810 remains in contact with outer surface of the case 100.

The accessory mounting component 302 may also have a support member 804, such as an arm or hook. The support member 804 can contact an outer edge of the case 100 to provide support to the accessory mounting component 302 when it is attached to the case 100. In addition, the support member 804 may at least partially extend around the edge of the case 100 to overlap at least a portion of the front face of the mobile device 200 (or of the case 100 installed thereon), thereby providing additional support and securing the accessory mounting component 302 to the case 100.

The cold shoe 320 of the accessory mounting component 302 may include substantially parallel channels 808 into which attachment structures of various accessories may be inserted. The channels 808 may be defined by walls 806 and the body of the accessory mounting component 302, as shown. In this configuration, an attachment structure of an accessory (e.g., a flash or microphone) can be inserted into the channels 808 and retained in place by the walls 806 and the body of the accessory mounting component 302.

In some embodiments, a hot shoe may be used instead of, or in addition to, a cold shoe. An accessory mounting component 302 having a hot shoe may have circuity to provide electrical power to the shoe or to accessories mounted thereto. The electrical power may be obtained from the mobile device 200 (e.g., the accessory mounting component 302 may interface electrically with the mobile device 200), or may be provided by a battery within or otherwise connected to the accessory mounting component 302. An accessory mounting component 302 having a hot shoe may also or alternatively have circuity to provide communication features to the hot shoe or to accessories mounted thereto. For example, the accessory mounting component 302 may provide wired or wireless communication with the mobile device 200 or with other devices.

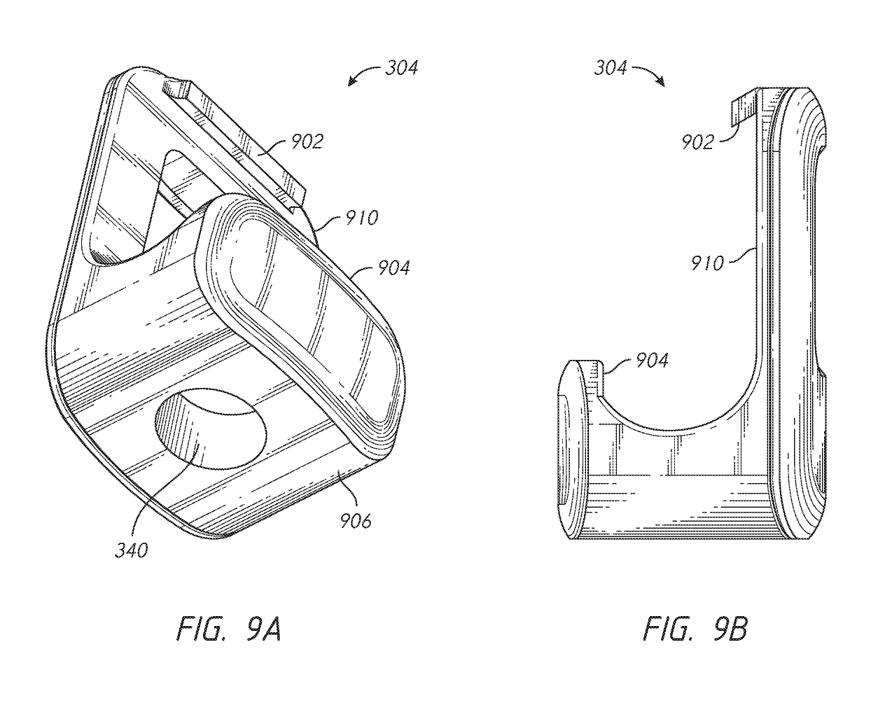

FIG. 9 shows an example of an accessory mounting component 304 with a threaded mounting portion 320. For convenience, some embodiments are described as a threaded mounting, but any other suitable temporary or removable connection can be used instead of or in addition to a threaded mounting anywhere in this specification, such as a snap fit, a bayonet fit, a friction fit, a retractable securing pin, etc. The accessory mounting component 304 can have a securement member 902 that is sized and/or shaped to be complementary to the attachment region 102 of the case 100. For example, the securement member 902 may be a tab, arm, or hook that is configured to be inserted into the channel of the attachment region 102 shown in FIG. 7, between the first and second sidewalls 122, 124. The securement member 902 may have two substantially parallel outer walls that are angled or sloped with respect to a surface 910 from which the securement member 902 protrudes. When the accessory mounting component 304 is attached to the case 100 via the attachment region 102, the securement member 902 may be inserted into the opening 104 of the attachment region 102. The surface 910 may be placed against the outer surface of the case 100, adjacent to the attachment region 102. The accessory mounting component 304 may then be moved along the channel of the attachment region 102 to a desired position on the case 100, and the securement member 902 may be retained within the channel while the surface 910 remains in contact with outer surface of the case 100.

The accessory mounting component 304 may also have a support member 904, such as an arm or hook. The support member 904 can contact an outer edge of the case 100 to provide support to the accessory mounting component 304 when it is attached to the case 100. In addition, the support member 904 may at least partially extend around the edge of the case 100 to overlap at least a portion of the front face of the mobile device 200 (or of the case 100 installed thereon), thereby providing additional support and helping to secure the accessory mounting component 304 to the case 100.

The threaded mounting portion 340 may be a threaded recess in an outer surface 906 of the support member 904, thereby allowing attachment of accessories having threaded securement members. For example, a tripod may have a threaded member extending from a surface of the tripod, and the threaded mounting portion may receive the threaded member. Thus, a mobile device 200 having a case 100 and accessory mounting component 304 installed may be used with a tripod. In some embodiments, a different mounting portion may be used to receive securement members of accessories. For example, a bayonet mount may be used, a friction fit or interference fit mount may be used, etc.

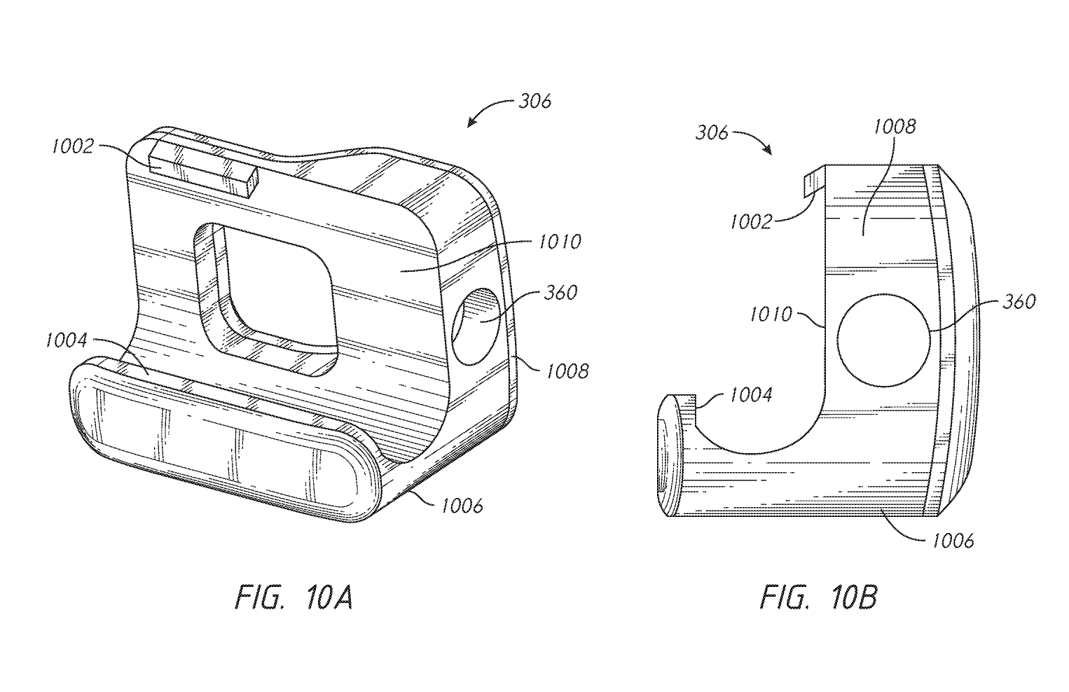

FIG. 10 shows another example of an accessory mounting component 306 with a threaded mounting portion 360. The accessory mounting component 360 shown in FIG. 10 can have a threaded mounting portion 360 on a lateral edge 1008 of the accessory mounting component 306, rather than on an outer surface of the support member 1004 of the accessory mounting component 306. In this configuration, the accessory mounting component 306 can allow, e.g., a tripod to be used with the mobile device 200 in a different orientation than the accessory mounting component 304 shown in FIG. 9. For example, the accessory mounting component 304 shown in FIG. 9 may allow a tripod to be used with the mobile device 200 in a “landscape” photography orientation, while the accessory mounting component 306 shown in FIG. 10 may allow a tripod to be used with the mobile device 200 in a “portrait” photography orientation.

The accessory mounting component 306 can have a securement member 1002 that is sized and/or shaped to be complementary to the attachment region 102 of the case 100. For example, the securement member 1002 may be a tab, arm, or hook that is configured to be inserted into the channel of the attachment region 102 shown in FIG. 7, between the first and second sidewalls 122, 124. The securement member 1002 may have two substantially parallel outer walls that are angled or sloped with respect to a surface 1010 from which the securement member 1002 protrudes. When the accessory mounting component 306 is attached to the case 100 via the attachment region 102, the securement member 1002 may be inserted into the opening 104 of the attachment region. The surface 1010 may be placed against the outer surface of the case 100, adjacent to the attachment region 102. The accessory mounting component 306 may then be moved along the channel of the attachment region 102 to a desired position on the case 100, and the securement member 1002 may be retained within the channel while the surface 1010 remains in contact with outer surface of the case 100.

The accessory mounting component 306 may also have a support member 1004, such as an arm or hook. The support member 1004 can contact an outer edge of the case 100 to provide support to the accessory mounting component 306 when it is attached to the case 100. In addition, the support member 1004 may at least partially extend around the edge of the case 100 to overlap at least a portion of the front face of the mobile device 200 (or of the case 100 installed thereon), thereby providing additional support and helping to secure the accessory mounting component 306 to the case 100.

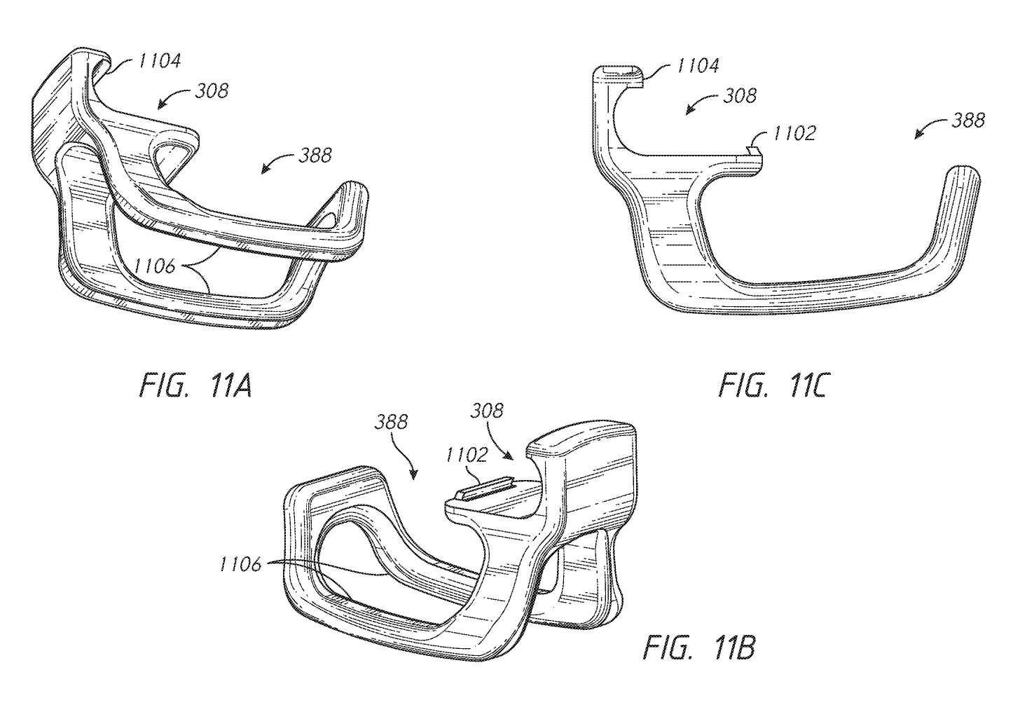

FIG. 11 shows an example of an accessory mounting component 308 with an integrated user handle 388. The user handle 388 can provide a comfortable and/or secure gripping structure during use of the mobile device 200. The handle 388 may include parallel or substantially parallel gripping members 1106 that are spaced apart. In some embodiments, the handle 388 may be a single structure, as shown in FIG. 4. In some embodiments, a sheath may be placed over the gripping members 1106 to increase comfort and/or provide a single gripping structure. In some embodiments, the handle 388 may include a hinge or folding element such that the handle may be pivoted or folded into or against the case 100 when not in use, and then unfolded or pivoted away from the case to be used.

The accessory mounting component 308 can have a securement member 1102 that is sized and/or shaped to be complementary to the attachment region 102 of the case 100. For example, the securement member 1102 may be a tab, arm, or hook that is configured to be inserted into the channel of the attachment region 102 shown in FIG. 7, between the first and second sidewalls 122, 124. The securement member 1102 may have two substantially parallel outer walls that are angled or sloped with respect to a surface 1110 from which the securement member 1102 protrudes. When the accessory mounting component 308 is attached to the case 100 via the attachment region 102, the securement member 1102 may be inserted into the opening 104 of the attachment region. The surface 1110 may be placed against the outer surface of the case 100, adjacent to the attachment region 102. The accessory mounting component 308 may then be moved along the channel of the attachment region 102 to a desired position on the case 100, and the securement member 1102 may be retained within the channel while the surface 1110 remains in contact with outer surface of the case 100.

The accessory mounting component 308 may also have a support member 1104, such as an arm or hook. The support member 1104 can contact an outer edge of the case 100 to provide support to the accessory mounting component 308 when it is attached to the case 100. In addition, the support member 1104 may at least partially extend around the edge of the case 100 to overlap at least a portion of the front face of the mobile device 200 (or of the case 100 installed thereon), thereby providing additional support and helping to secure the accessory mounting component 308 to the case 100.

Any of the embodiments or combinations of subsets or subassemblies from any embodiments in this specification may be manufactured according to various methods. For example, a method of manufacturing a case for a mobile electronic device may include providing an attachment portion configured to receive a securement member of a plurality of different mobile electronic device accessories, and providing an access portion configured to provide access to a component of the mobile electronic device. The provided attachment and access portions may be integrated into a case that is configured to be removably attachable to a housing of a mobile electronic device by a user. The method may also including providing an accessory configured to be removably attached to the case, such as handle, flash component, tripod mount, accessory mounting component, microphone, etc. As another example, a method of manufacturing a case for a mobile electronic device may include providing an outer surface of the case, providing a channel recessed at least partly below the outer surface of the case, and providing an access region configured to provide access to a component of a mobile device onto which the case is removably attached. The channel may be configured to receive a portion of a mobile device accessory when the mobile device accessory is removably attached to the case. The method may also including providing an accessory configured to be removably attached to the case, such as handle, flash component, tripod mount, accessory mounting component, microphone, etc.

Any combinations of embodiments or combinations of subsets or subassemblies from any embodiments in this specification can be used together. For example, and without limitation, any features of any accessory or accessory mounting component of the embodiments disclosed and/or illustrated in connection with FIGS. 3-4 can be used with any accessory or accessory mounting component of FIGS. 8-11, or any receiving structure (e.g., channel) of FIG. 1, 2, 6, or 7, etc.

The following is claimed:

1. A case for a mobile electronic device, the case comprising:
an attachment region configured to receive a securement member of a plurality of different mobile electronic device accessories; and
an access region configured to provide access to a component of a mobile electronic device;
wherein the case is configured to be removably attachable to a housing of the mobile electronic device by a user.

2. The combination of the case of claim 1 and a mobile electronic device accessory, wherein the mobile electronic device accessory comprises a securement member configured to be inserted into the attachment region.

3. The combination of claim 2, wherein the mobile electronic device accessory comprises a flash component, a microphone, a tripod mount, an accessory mount, or a handle.

4. The combination of the case of claim 1 and the mobile electronic device.

5. The case of claim 1, wherein a portion of the case at least partially surrounded by the attachment region is configured to be removable and replaceable by a plurality of different types of mobile device accessories.

6. The case of claim 1, wherein the attachment region comprises a channel recessed at least partly below an outer surface of the case.

7. The case of claim 6, wherein the channel extends between a first sidewall and a second sidewall, and wherein the first sidewall is substantially parallel to the second sidewall.

8. The case of claim 6, wherein an attachment structure extends at least partially over the channel from the outer surface of the case, and wherein the attachment structure is configured to retain the securement member received by the attachment region.

9. The case of claim 6, wherein the channel comprises a plurality of alignment structures configured to resist movement of a mobile electronic device accessory attached to the case.

10. The case of claim 1, wherein the access region is configured to provide access to an onboard camera lens of the mobile electronic device.

11. The case of claim 10, wherein the access region is configured to receive a removably attachment lens component, and wherein the access region is configured to align the removably attachable lens component with the onboard camera lens of the mobile electronic device.

12. A removably attachable case for a mobile device, the removably attachable case comprising:
an outer surface;
a channel recessed at least partly below the outer surface, the channel configured to receive a portion of a mobile device accessory when the mobile device accessory is removably attached to the case; and
an access region configured to provide access to a component of a mobile device.

13. The removably attachable case of claim 12, wherein the channel comprises a continuous channel substantially equidistant from a perimeter of the outer surface.

14. The removably attachable case of claim 12, wherein the channel extends between a first sidewall and a second sidewall, and wherein the first sidewall is substantially parallel to the second sidewall.

15. The case of claim 12, wherein an attachment structure extends at least partially over the channel from the outer surface of the case, and wherein the attachment structure is configured to retain the securement member of the mobile device accessory received by the channel.

16. The removably attachable case of claim 12, wherein the access region is configured to receive a removably attachment lens component, and wherein the access region is configured to align the removably attachable lens component with an onboard camera lens of the mobile device.

17. A method of manufacturing a case for a mobile electronic device, the method comprising:
providing an attachment portion configured to receive a securement member of a plurality of different mobile electronic device accessories; and
providing an access portion configured to provide access to a component of a mobile electronic device;
wherein the case is configured to be removably attachable to a housing of the mobile electronic device by a user.

18. The method of manufacturing of claim 17, further comprising providing a mobile electronic device accessory.

19. The method of manufacturing of claim 17, wherein the attachment portion comprises a channel recessed below an outer surface of the case, wherein an attachment structure extends at least partially over the channel from the outer surface of the case, and wherein the attachment structure is configured to retain the securement member of the mobile device accessory received by the attachment portion.

20. The method of manufacturing of claim 17, wherein the access portion is configured to receive a removably attachment lens component, and wherein the access portion is configured to align the removably attachable lens component with an onboard camera lens of the mobile electronic device.
